(19) United States
(12) Patent Application Publication
(10) Pub. No.: US 2005/0046647 A1
(43) Pub. Date: Mar. 3, 2005

(54) Method of driving data lines, apparatus for driving data lines and display device having the same

(76) Inventor: Sung-Ho Lee, Hwaseong-gun (KR)

Correspondence Address: CANTOR COLBURN LLP, 55 Griffin Road South, Bloomfield, CT, 06002, US

(21) Appl. No.: 10/923,656

(22) Filed: Aug. 20, 2004

(30) Foreign Application Priority Data
Sep. 2, 2003 (KR) 2003-61061

(51) Int. Cl. G09G 5/10

(52) U.S. Cl. 345/690

(57) ABSTRACT

An apparatus for driving a plurality of data lines coupled to a plurality of pixels includes a gray scale voltage selection circuit, a shift register and an output circuit. The gray scale voltage selection circuit selects one of a plurality of gray scale voltage signals based on image data to output the selected gray scale voltage signal. The shift register sequentially generates enable signals in response to a start signal and shifted clock signals. The output circuit sequentially provides the data lines with the selected gray scale voltage signals as data signals in response to the enable signals.

### CROSS-REFERENCE TO RELATED APPLICATIONS

This application relies for priority upon Korean Patent Application No. 2003-61061 filed on Sep. 2, 2003, the contents of which are herein incorporated by reference in its entirety.

### BACKGROUND OF THE INVENTION

1. Field of the Invention

The present invention relates to a method of driving a plurality of data lines, an apparatus for driving the data lines, and display device having the apparatus.

2. Description of the Related Art

Resolutions of liquid crystal display devices used in mobile communication devices increase, for example from 128×160 to 178×220 or 240×320 (Quarter VGA).

The number of output channels of a driver IC (Integrated Circuit) for driving the liquid crystal display device increase according to the increase of the resolution of the liquid crystal display device. The increased output channels of the driver IC requires an increase of starting current (or inrush current), and thus an output of a power supply for supplying the starting current is reduced since the power supply has a limited current capacity.

Power supply having charging pump configuration performs abnormal regulating operation when abrupt inrush current is generated. Therefore, the display quality of the liquid crystal display device is deteriorated instantaneously or the liquid crystal display device does not display an image instantaneously. In addition, the abrupt inrush current induces abnormal operation of the liquid crystal display device such as instantaneous power voltage drop.

### SUMMARY OF THE INVENTION

Accordingly, the present invention is provided to substantially obviate one or more problems due to limitations and disadvantages of the related art.

According to embodiments of the present invention, there is provided a method of driving a plurality of data lines. The data signals of which output timing is controlled are provided to the data lines.

According to embodiments of the present invention, there is provided an apparatus for driving a plurality of data lines. The apparatus controls output timing of data signals to provide the data signals to the data lines.

According to embodiments of the present invention, there is provided a display device having above apparatus.

In some exemplary embodiments, a method of driving a plurality of data lines coupled to a plurality of pixels includes checking whether a scan signal is output to at least one of scan lines and providing at least two data lines with data signals respectively having different active periods when the scan signal is output to said at least one of the scan lines. The scan lines are coupled to the pixels, the scan signal has a first active period, and the at least two data lines are coupled to the at least one of the scan lines to which the scan signal is output.

In another exemplary embodiments, an apparatus for driving a plurality of data lines coupled to a plurality of pixels includes a gray scale voltage selection circuit, a shift register and an output circuit. The gray scale voltage selection circuit is configured to select one of a plurality of gray scale voltage signals based on image data to output the selected gray scale voltage signal. The shift register is configured to sequentially generate enable signals in response to a start signal and shifted clock signals. The output circuit is configured to sequentially provide the data lines with the selected gray scale voltage signals as data signals in response to the enable signals, the output circuit being coupled to the data lines.

For example, a scan signal having a first active period is applied to one of scan lines coupled to the pixels, and a front edge of each of the data signals begins at different times from each other, and the front edges of the data signals are within the first active period.

In still another exemplary embodiments, a display device includes a display panel, a timing controller, a scan driver and a data driver. The display panel includes a plurality of pixels coupled to a plurality of data lines and a plurality of scan lines. The timing controller is configured to receive first image signal and a first timing signal corresponding to the first image signal to generate a second image signal, second and third timing signals. The scan driver is configured to sequentially generate a plurality of scan signals for activating the scan lines based on the second timing signal. The data driver is configured to generate a plurality of gray scale voltage signals corresponding to the second image signal based on the third timing signal and to sequentially output the gray scale voltage signals as data signals to the data lines.

For example, the scan signals have a first active period, the data driver sequentially outputs first data signals to first data lines coupled to at least one of the scan lines to which a scan signal is output, and the first data signals respectively have different active periods each other.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a block diagram showing a liquid crystal display device according to one exemplary embodiment of the present invention;

FIG. 2 is a block diagram showing an example of a data driver of FIG. 1;

FIG. 3 is a block diagram showing an example of an output section of FIG. 2;

FIG. 4 is a timing diagram showing data signals output from the data driver of FIG. 1 according to one exemplary embodiment of the present invention; and

FIG. 5 is a timing diagram showing data signals output from the data driver of FIG. 1 according to another exemplary embodiment of the present invention.

### DESCRIPTION OF EMBODIMENTS

Detailed illustrative embodiments of the present invention are disclosed herein. However, specific structural and functional details disclosed herein are merely representative for purposes of describing exemplary embodiments of the present invention. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

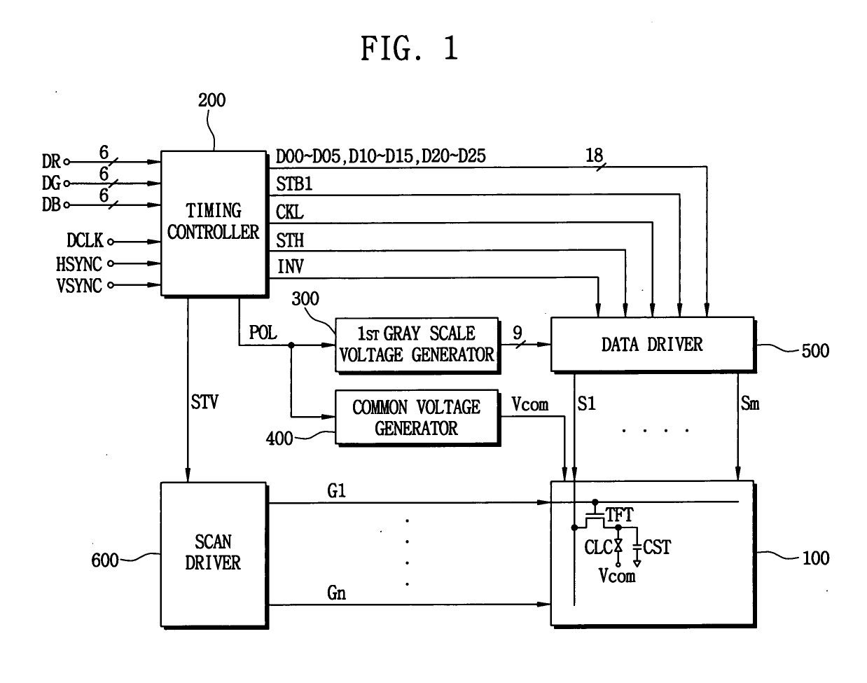

FIG. 1 is a block diagram showing a liquid crystal display device according to one exemplary embodiment of the present invention.

Referring to FIG. 1, the liquid crystal display device includes a liquid crystal display panel 100, a timing controller 200, a first gray scale voltage generator 300, a common voltage generator 400, a data driver 500 and a scan driver 600. A driver circuit for driving the liquid crystal display device includes the timing controller 200, the first gray scale voltage generator 300, the common voltage generator 400, the data driver 500 and the scan driver 600.

The liquid crystal display panel 100 includes a plurality of pixels. The pixels are regions defined by a plurality of scan lines (or gate lines) and a plurality of data lines. The scan lines may be arranged in a row direction. The data lines may be arranged in a column direction. Each of the pixels includes a switching element, a liquid crystal capacitor CLC and a storage capacitor CST. The switching element may be a thin film transistor (TFT), and are connected to a scan line and a data line. A first end of the liquid crystal capacitor CLC is connected to a drain electrode of the TFT and a second end of the liquid crystal capacitor CLC is connected to a common electrode to which a common voltage Vcom is applied. The storage capacitor CST charges the liquid crystal capacitor CLC during a vertical synchronization period.

R (red) data signal, G (Green) data signal (DG) or B (Blue) data signal (DB) are provided to a source electrode of the TFT, the common voltage Vcom is applied to the second end of the liquid crystal capacitor CLC via the common electrode, and scan signals are applied to gate electrodes of the TFTs. The scan signals are generated based on a horizontal synchronization signal HSYNC and a vertical synchronization signal VSYNC.

The timing controller 200 converts R (red) data signal (DR), G (Green) data signal (DG) and B (Blue) data signal (DB) into R (red) data signal, G (Green) data signal and B (Blue) data signal, respectively. The R (red) data signal, G (Green) data signal and B (Blue) data signal correspond to image data signals. For example, the R (red) data signal (DR), G (Green) data signal (DG) and B (Blue) data signal (DB) respectively are comprised of 6 bits, and the image data signals (D00-D05, D10-D15, D20-D25) are comprised of 18 bits. The timing controller 200 provides the image data signals (D00-D05, D10-D15, D20-D25) to the data driver 500.

The timing controller 200 generates a first strobe signal STB1, a clock signal CLK, a horizontal start pulse STH and a data inverting signal INV based on a dot clock signal DCLK, the horizontal synchronization signal HSYNC and the vertical synchronization signal VSYNC to provide the data driver with the first strobe signal STB1, the clock signal CLK, the horizontal start pulse STH and the data inverting signal INV. The timing controller 200 generates a polarization signal POL to provide the first gray scale voltage generator 300 and the common voltage generator 400 with the signal POL. The timing controller 200 generates a vertical start pulse STV to provide the scan driver 600 with the vertical start pulse STV. The first strobe signal STB1 may have the same time period as the horizontal synchronization signal HSYNC. The clock signal CLK may have the same frequency as the dot clock signal DCLK, or may have different frequency from the dot clock signal DCLK.

The horizontal start pulse STH may have the same time period as the horizontal synchronization signal HSYNC.

The POL signal is inverted every horizontal synchronization period so that the liquid crystal display panel may be driven by an alternating current method.

The vertical start pulse STV has the same time period as the vertical synchronization signal VSYNC. The data inverting signal INV contributes to the reduction of power consumption of the timing controller 200.

For example, the first gray scale voltage generator 300 includes a resistor array, a switch and a voltage follower. The resistor array has serially connected resistors, and the switch is connected to both ends of the resistor array. The resistors may have the same resistance or different resistances. The voltage follower is connected to each of the resistors. The first gray scale voltage generator 300 receives the POL signal, amplifies a plurality of first gray scale voltage signals and provides the data driver 500 with the amplified first gray scale voltage signals. The first gray scale voltage signals are used for gamma correction. The first gray scale voltage signals are inverted in response to the POL signal to swing between a positive voltage level and a negative voltage level with respect to the voltage level of the common voltage Vcom.

The common voltage generator 400 receives the POL signal and provides the common electrode of the liquid crystal display panel 100 with a common voltage having a ground level or a common voltage having a voltage level VDD. For example, the common voltage generator 400 provides the common electrode of the liquid crystal display panel 100 with the common voltage having the ground level when the POL signal has a high level, and the common voltage having the voltage level VDD when the POL signal has a low level.

The data driver 500 divides the voltage levels of the amplified first gray scale voltage signals to generate second gray scale voltage signals, selects one of the divided voltage levels of the second gray scale voltage signals based on the image data signals (D00-D05, D10-D15, D20-D25), and sequentially provides the source electrodes of the TFTs with the selected second gray scale voltage signals. The data driver 500 may sequentially provide the source electrodes of the TFTs with the selected second gray scale voltage signals. Alternatively, after the selected second gray scale voltage signals are divided into a plurality of groups, the data driver 500 may sequentially provide the source electrodes of the TFTs with the selected second gray scale voltage signals in a group.

For example, when the selected second gray scale voltage signals are sequentially provided to the source electrodes of the TFTs, a rising edge of each of the second gray scale voltage signals begins at different times from each other, the rising edges of the second gray scale voltage signals are within an active period of the scan signal, and a falling edge of each of the second gray scale voltage signals begins at substantially the same time each other.

For example, when the selected second gray scale voltage signals are sequentially provided in a group to the source electrodes of the TFTs, rising edges of the second gray scale voltage signals belonging to a group begin at different times from rising edges of the second gray scale voltage signals belonging to the other group, the rising edges of the second gray scale voltage signals are within the active period of the scan signal, and a falling edge of each of the second gray scale voltage signals begins at substantially the same time each other.

Alternately, for example, when the selected second gray scale voltage signals are sequentially provided in a group to the source electrodes of the TFTs, a rising edge of a second gray scale voltage signal belonging to a group begins at different times from a rising edge of the other second gray scale voltage signals belonging to the same group, the rising edges of the second gray scale voltage signals are within the active period of the scan signal, and a falling edge of each of the second gray scale voltage signals begins at substantially the same time each other.

The scan driver 600 sequentially generates a plurality of scan signals G1, G2, . . . , Gn in response to the vertical start pulse STV provided from the timing controller 200, and provides the gate electrodes of the TFTs of the liquid crystal display panel 100 with the scan signals G1, G2, . . . , Gn.

Although above exemplary embodiments discuss the liquid crystal display device as a display device, the active matrix driving display devices such as an organic electroluminescence device or a plasma display device (PDP) could be utilized.

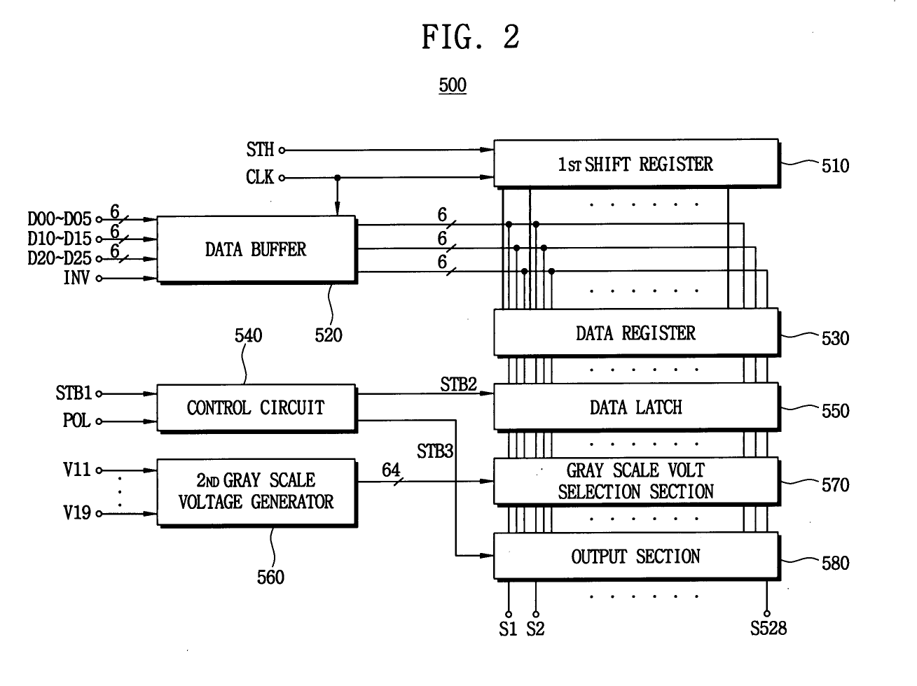

FIG. 2 is a block diagram showing an example of a data driver of FIG. 1.

Referring to FIGS. 1 and 2, the data driver 500 includes a first shift register 510, a data buffer 520, a data register 530, a control circuit 540, a data latch 550, a second gray scale voltage generator 560, a gray scale voltage selection section 570 and an output section 580. For example, the data driver 580 drives a liquid crystal display panel having a resolution of 176×220×3.

The first shift register 510 shifts the horizontal start pulse STH in response to the clock signal CLK provided from the timing controller 200. For example, the first shift register 510 is a serial-in parallel-out shift register having 176 flip flops (DFF) that output 176 parallel sampling pulses.

The data buffer 520 inverts the 18-bit image data signals (D00-D05, D10-D15, D20-D25) provided from the timing controller 200 based on the data inverting signal INV, and provides the data register 530 with the inverted image data signals (\overline{D00-D05}, \overline{D10-D15} and \overline{D20-D25}).

Alternately, the data buffer 520 may provide the data register 530 with the image data signals (D00-D05, D10-D15, D20-D25) provided from the timing controller 200 without inverting the 18-bit image data signals (D00-D05, D10-D15, D20-D25).

The data register 530 outputs the image data signals (D00-D05, D10-D15, D20-D25) or the inverted image data signals (\overline{D00-D05}, \overline{D10-D15} and \overline{D20-D25}) in response to the 176 parallel sampling pulses.

The control circuit 540 includes a plurality of inverters serially connected each other. The control circuit 540 generates second and third strobe signals STB2 and STB3, provides the data latch 16 with the second strobe signal STB2 and provides the output section 580 with the third strobe signal STB3. The second strobe signal STB2 is delayed by a given time period with respect to the first strobe signal STB1. The third strobe signal STB3 has an inverted phase with respect to the second strobe signal STB2.

The data latch 550 receives the image data signals (or the inverted image data signals) in response to a rising edge of the second strobe signal STB2 provided from the control circuit 540, and latches the image data signals (or the inverted image data signals) for the horizontal synchronization period. The horizontal synchronization period is referred to as a time period between the present second strobe signal STB2 and the next second strobe signal STB2.

The second gray scale voltage generator 560, for example, includes cascade-connected resistors. The second gray scale voltage generator 560 divides the first gray scale voltage signals provided from the first gray scale voltage generator 300 to provide the divided first gray scale voltage signals as second gray scale voltage signals to the gray scale voltage selection section 570. For example, when the second gray scale voltage generator 560 receives 9 first gray scale voltage signals from the first gray scale voltage generator 300, the second gray scale voltage generator 560 applies the 9 first gray scale voltage signals to the cascade-connected resistors and generates 64 second gray scale voltage signals (V1, V2, . . . , V64).

The second gray scale voltage selection section 570, for example, selects one second gray scale voltage signal among the 64 second gray scale voltage signals (V1, V2, . . . , V64) provided from the second gray scale voltage generator 560 based on the 16-bit image data signals (D00-D05, D10-D15, D20-D25) or the inverted image data signals (\overline{D00-D05}, \overline{D10-D15} and \overline{D20-D25}) provided from the data latch 550, and provide the output section 580 with the selected second gray scale voltage signal.

The output section 580 stores the second gray scale voltage signals output from the gray scale voltage selection section 570, and sequentially applies the second gray scale voltage signals to the data lines of the liquid crystal display panel 100 in response to the third strobe signal STB3.

The second gray scale voltage signals may sequentially be applied to the data lines. Alternatively, after the second gray scale voltage signals are divided into a plurality of groups, the second gray scale voltage signals may sequentially be applied to the data lines in a group. Therefore, the generation of inrush currents may be reduced even though the number of the output channels of the data driver increases.

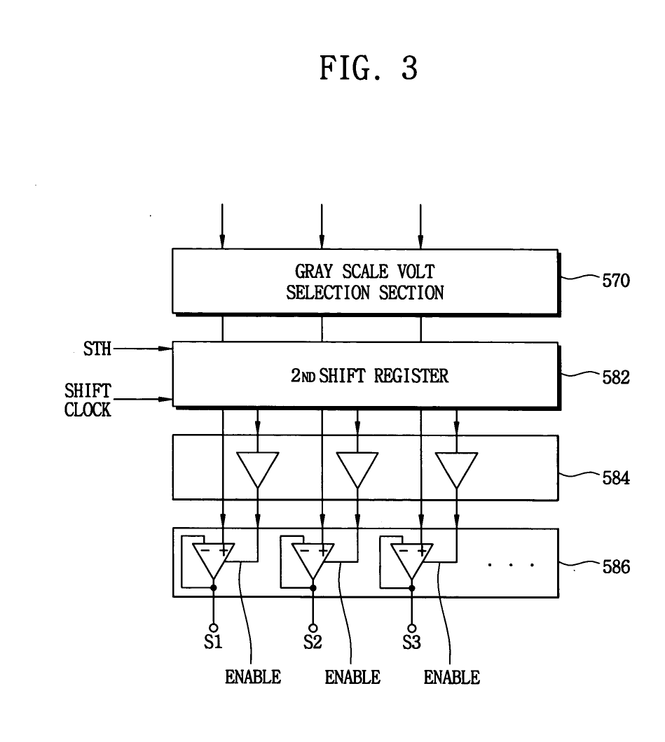

FIG. 3 is a block diagram showing an example of an output section of FIG. 2. The output section 580 of FIG. 3, for example, includes a plurality of operational amplifiers.

Referring to FIGS. 1, 2 and 3, the output section 580 includes a second shift register 582, a latch 584 and an amplifier 586.

The second shift register 582 receives the horizontal start pulse STH and the shifted clock signals SHIFT CLOCK, and sequentially generates enables signals ENABLE to sequentially output the enables signals ENABLE to the latch 584.

The latch 584 latches the enables signals ENABLE to sequentially output the enables signals ENABLE to the amplifier 586.

The amplifier 586 amplifies, for example, one of the 64 second gray scale voltage signals provided from the gray scale voltage selection section 570 in response to the enables signals ENABLE provided from the latch 584, and outputs the amplified second gray scale voltage signals to the data lines of the liquid crystal display panel 100.

Alternately, the latch 584 may be removed from the output section 580, and the enables signals ENABLE provided from the second shift register 582 may be applied directly to the amplifier 586 without using the latch 584.

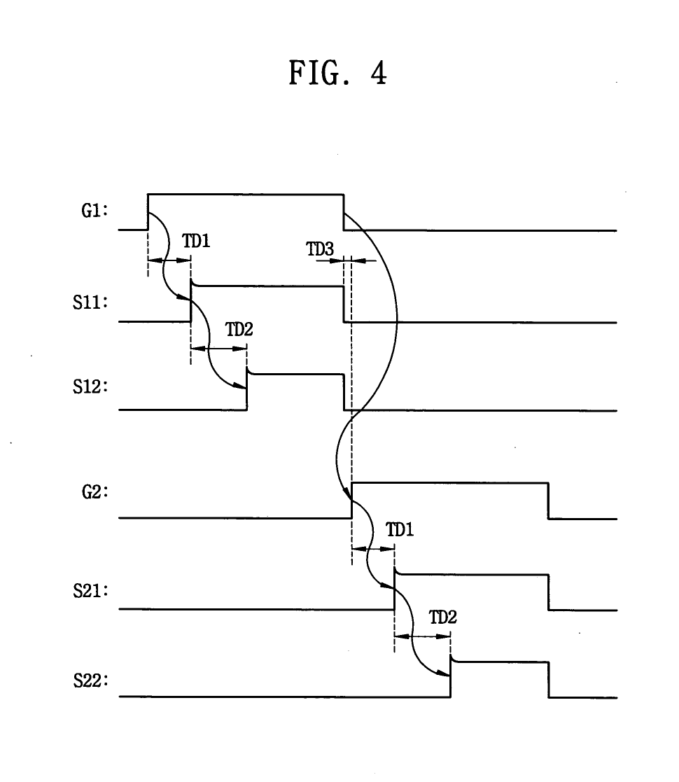

FIG. 4 is a timing diagram showing data signals output from the data driver of FIG. 1 according to one exemplary embodiment of the present invention.

Referring to FIGS. 1, 2, 3 and 4, when a first scan signal G1 for activating a first scan line is applied to the first scan line, the data driver 500 outputs a first data signal S11 to a first data line, and outputs a second data signal S12 to a second data line. For example, an active period of the first data signal S11 is about 90% of an active period of the first scan signal G1, and an active period of the second data signal S12 is about 50% of the active period of the first scan signal G1.

The first data signal S11 has a rising edge that is delayed by a first time delay TD1 with respect to a rising edge of the first scan signal G1. The first data signal S11 is inactivated according as the first scan signal G1 is inactivated. For example, the first data signal S11 has a falling edge that is synchronized with a falling edge of the first scan signal G1.

The second data signal S12 has a rising edge that is delayed by a second time delay TD2 with respect to the rising edge of the first data signal S11. The second data signal S12 is inactivated according as the first scan signal G1 is inactivated. For example, the second data signal S12 has a falling edge that is synchronized with the falling edge of the first scan signal G1. A second scan signal G2 is activated according as the first scan signal G1 is inactivated. For example, the second scan signal G2 has a rising edge synchronized with the falling edge of the first scan signal G1. Alternately, the second scan signal G2 has a rising edge that is delayed by a third time delay TD3 with respect to the falling edge of the first scan signal G1.

The active period of the second data signal S12 may have enough time period to charge the liquid crystal capacitor CLC without failure.

Alternately, the first data signal S11 may be applied to odd numbered data lines, and the second data signal S12 may be applied to even numbered data lines.

Alternately, the first data signal S11 may be applied to a first data line, and the second data signal S12 may be applied to the last data line. In this case, shifted data signals having active periods respectively shifted by a given time delay may be applied to intermediate data lines between the first and last data lines. For example, the shifted data signals respectively have different active periods each of which is between the starting point of the active period of the first data signal S11 and the starting point of the active period of the second data signal S12.

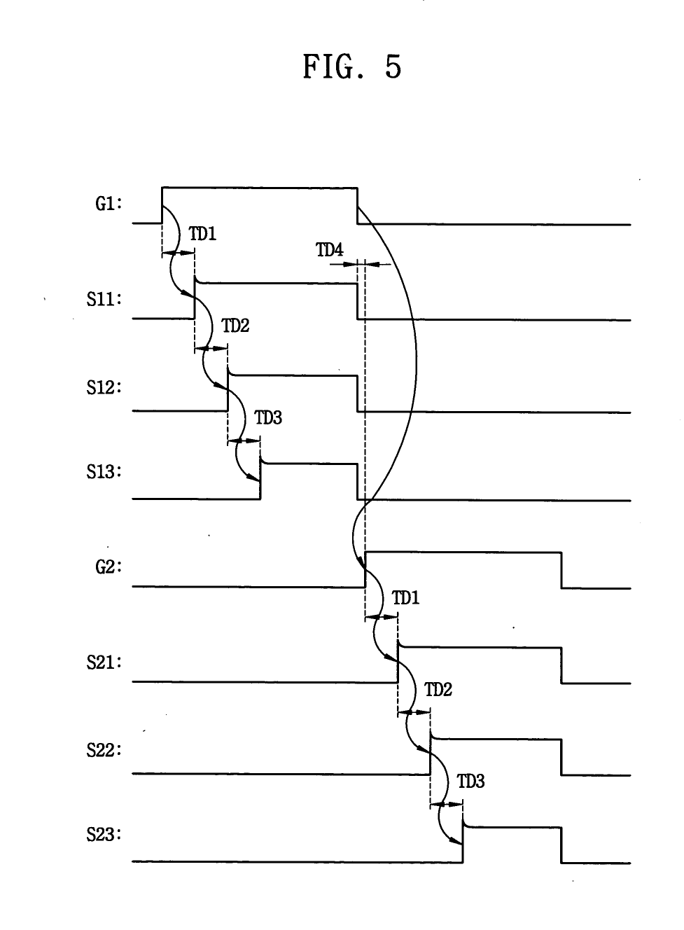

FIG. 5 is a timing diagram showing data signals output from the data driver of FIG. 1 according to another exemplary embodiment of the present invention.

Referring to FIGS. 1, 2, 3 and 5, when a first scan signal G1 for activating a first scan line is applied to the first scan line, the data driver 500 outputs a first data signal S11 to a first data line, outputs a second data signal S12 to a second data line, and outputs a third data signal S13 to a third data line. For example, an active period of the first data signal S11 is about 90% of an active period of the first scan signal G1, an active period of the second data signal S12 is about 70% of the active period of the first scan signal G1, and an active period of the third data signal S13 is about 50% of the active period of the first scan signal G1.

The first data signal S11 has a rising edge that is delayed by a first time delay TD1 with respect to a rising edge of the first scan signal G1. The first data signal S11 is inactivated according as the first scan signal G1 is inactivated. For example, the first data signal S11 has a falling edge that is synchronized with a falling edge of the first scan signal G1.

The second data signal S12 has a rising edge that is delayed by a second time delay TD2 with respect to the rising edge of the first data signal S11. The second data signal S12 is inactivated according as the first scan signal G1 is inactivated. For example, the second data signal S12 has a falling edge that is synchronized with the falling edge of the first scan signal G1.

The third data signal S13 has a rising edge that is delayed by a third time delay TD3 with respect to the rising edge of the second data signal S12. The third data signal S13 is inactivated according as the first scan signal G1 is inactivated. For example, the third data signal S13 has a falling edge that is synchronized with the falling edge of the first scan signal G1.

A second scan signal G2 is activated according as the first scan signal G1 is inactivated. For example, the second scan signal G2 has a rising edge synchronized with the falling edge of the first scan signal G1. Alternately, the second scan signal G2 has a rising edge that is delayed by a fourth time delay TD4 with respect to the falling edge of the first scan signal G1.

The active period of the second and third data signals S12 and S13 respectively may have enough time period to charge the liquid crystal capacitor CLC without failure.

In the exemplary embodiment of FIG. 5, the active periods of the first, second and third data signals decrease in the order named. However, the active periods of the first, second and third data signals may increase in the order named. Alternately, the active periods of the first, second and third data signals may decrease and then increase in the order named. Alternately, the active periods of the first, second and third data signals may increase and then decrease in the order named.

Alternately, the first data signal S11 may be applied to (3n-2)th data lines(n is a natural number), the second data signal S12 may be applied to (3n-1)th data lines, and the third data signal S13 may be applied to (3n)th data lines.

Alternately, the first data signal S11 may be applied to a first data line, the second data signal S12 may be applied to intermediate data lines between the first and last data lines, and the third data signal S13 may be applied to the last data line. In this case, the second data signal S12 may have various active periods respectively shifted by a given time delay. For example, the second data signal S12 may have different active periods each of which is between the starting point of the active period of the first data signal S11 and the starting point of the active period of the second data signal S12. For example, the second data signal S12 may have different active periods each of which is between the starting point of the active period of the second data signal S12 and the starting point of the active period of the third data signal S13.

While the exemplary embodiments of the present invention and its advantages have been described in detail, it should be understood that various changes, substitutions and alterations can be made herein without departing from the scope of the invention as defined by appended claims.

1. A method of driving a plurality of data lines coupled to a plurality of pixels, the method comprising:
checking whether a scan signal is output to at least one of scan lines, the scan lines coupled to the pixels, the scan signal having a first active period; and
providing at least two data lines with data signals respectively having different active periods when the scan signal is output to said at least one of the scan lines, said at least two data lines coupled to said at least one of the scan lines to which the scan signal is output.

2. The method of claim 1, wherein a maximum width of the active periods of the first data signals is less than or equal to the first active period.

3. The method of claim 1, wherein said providing at least two data lines with data signals includes:
outputting a first data signal having a second active period to a first data line in response to a front edge of the scan signal, the first data line coupled to said at least one of the scan lines to which the scan signal is output, a front edge of the first data signal being delayed by a first time period with respect to a front edge of the scan signal, and the first data signal being active while the scan signal is active, the first data line being an odd numbered data line; and
outputting a second data signal having a third active period to a second data line after the first data signal is activated, the second data line coupled to said at least one of the scan lines to which the scan signal is output, a front edge of the second data signal being delayed by a second time period with respect to a front edge of the first data signal, the second data signal being active while the scan signal is active, the second data line being an even numbered data line.

4. The method of claim 3, wherein said providing at least two data lines with data signals further includes outputting a third data signal having a fourth active period to a third data line after the second data signal is activated, the third data line coupled to said at least one of the scan lines to which the scan signal is output, a front edge of the third data signal being delayed by a third time period with respect to a front edge of the second data signal, the third data signal being active while the scan signal is active.

5. The method of claim 1, wherein a width of the fourth active period is less than or equal to the third active period.

6. An apparatus for driving a plurality of data lines coupled to a plurality of pixels, the apparatus comprising:
a gray scale voltage selection circuit that is configured to select one of a plurality of gray scale voltage signals based on image data to output the selected gray scale voltage signal;
a shift register that is configured to sequentially generate enable signals in response to a start signal and shifted clock signals; and
an output circuit that is configured to sequentially provide the data lines with the selected gray scale voltage signals as data signals in response to the enable signals, the output circuit being coupled to the data lines.

7. The apparatus of claim 6, further including a latch that is configured to latch the enable signals to output the enable signals to the output circuit.

8. The apparatus of claim 6, wherein the shift register generates a first enable signal in response to a start signal, and sequentially generates the other enable signals in response to the shifted clock signals.

9. The apparatus of claim 6, wherein the start signal is a horizontal start signal (STH).

10. The apparatus of claim 6, wherein a scan signal having a first active period is applied to one of scan lines coupled to the pixels, and wherein the shift register outputs a first enable signal so that a first data signal having a second active period be output to a first data line coupled to said one of the scan lines to which the scan signal is output, and the shift register outputs the other enable signals so that a second data signal having a third active period be output to a second data line coupled to said one of the scan lines to which the scan signal is output, a width of the second active period is less than or equal to a width of the first active period, a width of the third active period is less than the width of the second active period.

11. The apparatus of claim 6, wherein a scan signal having a first active period is applied to one of scan lines coupled to the pixels, and wherein a front edge of each of the data signals begins at different times from each other, and the front edges of the data signals are within the first active period.

12. The apparatus of claim 6, wherein a scan signal having a first active period is applied to one of scan lines coupled to the pixels, and wherein the data signals are divided into a plurality of groups, front edges of first data signals belonging to a first group begin at different times from front edges of second data signals belonging to a second group, and the front edges of the data signals are within the first active period.

13. The apparatus of claim 12, wherein a front edge of third data signal belonging to first group begins at different times from a front edge of fourth data signal belonging to the first group, or a front edge of third data signal belonging to first group begins at substantially a same time as a front edge of fourth data signal belonging to the first group.

14. A display device comprising:
a display panel including a plurality of pixels coupled to a plurality of data lines and a plurality of scan lines;
a timing controller that is configured to receive first image signal and a first timing signal corresponding to the first image signal to generate a second image signal, second and third timing signals;
a scan driver that is configured to sequentially generate a plurality of scan signals for activating the scan lines based on the second timing signal; and
a data driver that is configured to generate a plurality of gray scale voltage signals corresponding to the second image signal based on the third timing signal and to sequentially output the gray scale voltage signals as data signals to the data lines.

15. The display device of claim 14, wherein the scan signals have a first active period, and wherein the data driver sequentially outputs first data signals to first data lines coupled to at least one of the scan lines to which a scan signal is output, the first data signals respectively have different active periods each other.

16. A display device of claim 14, wherein the data driver includes:
a gray scale voltage selection circuit that is configured to select one of the gray scale voltage signals based on the second image signal to output the selected gray scale voltage signal;
a shift register that is configured to sequentially generate enable signals in response to a start signal and shifted clock signals; and
an output circuit that is configured to sequentially provide the data lines with the selected gray scale voltage signals in response to the enable signals, the output circuit being coupled to the data lines.

17. The display device of claim 16, wherein the start signal is provided from the timing controller.

18. The display device of claim 14, wherein a front edge of each of the gray scale voltage signals begins at different times from each other, and the front edges of the gray scale voltage signals are within active periods of the scan signals.

19. The display device of claim 14, wherein the gray scale voltage signals are divided into a plurality of groups, front edges of first gray scale voltage signals belonging to a first group begin at different times from front edges of second gray scale voltage signals belonging to a second group, and the front edges of the gray scale voltage signals are within active periods of the scan signals.

20. The display device of claim 14, wherein the gray scale voltage signals are divided into a plurality of groups, a tail edge of a first gray scale voltage signal belonging to a first group begins at substantially a same time as a tail edge of a second gray scale voltage signal belonging to the first group.
